(19) United States
(12) Patent Application Publication
(10) Pub. No.: US 2009/0121165 A1
(43) Pub. Date: May 14, 2009

(54) DEVICE AND A METHOD FOR GENERATING DATA RELATING TO PARTICLES IN A PARTICULATE MATERIAL

(76) Inventor: Abdelwahab Aroussi, Nottingham (GB)

Correspondence Address: The VON HELLENS LAW FIRM, LTD., 7330 N 16TH STREET, SUITE C 201, PHOENIX, AZ, 85020, US

(21) Appl. No.: 11/816,434

(22) PCT Filed: Feb. 16, 2006
(86) PCT No.: PCT/GB06/00534

§ 371 Date: Jun. 26, 2008

(30) Foreign Application Priority Data
Feb. 16, 2005 (GB) 0503184.4

(51) Int. Cl. G01F 1/704

(52) U.S. Cl. 250/573

(57) ABSTRACT

In the field of multi-phase flows there is a need for a device and a method, for generating data relating to particles in a particulate material suspended in a fluid medium flowing within a pipe in a given direction, which provides more accurate data about the particles than conventional direct imaging techniques. A device (30; 50), for generating data relating to particles in a particulate material suspended in a fluid medium flowing within a pipe (34; 54) in a given flow direction (FD), comprises a light source (32) arranged to illuminate a portion of the flow, and an image acquisition unit (40) for capturing an image of the particles as they pass through the illuminated portion of the flow. The image acquisition unit (40) has a predetermined focal plane (41), and is arranged so that the focal plane (41) is inclined relative to the flow direction (FD) of the particles. The device (30; 50) also includes a processing unit which is in communication with the image acquisition unit (40). The processing unit enhances the image and processes the enhanced image to generate data relating to the particles captured therein. A method, for generating data relating to particles in a particulate material suspended in a fluid medium flowing within a pipe (34; 54) in a given flow direction (FD), comprises the steps of (i) illuminating a portion of the flow, (ii) arranging an image acquisition unit (40) having a predetermined focal plane (41) so that the focal plane (41) is inclined relative to the flow direction (FD) of the particles, (iii) capturing an image of the particles as they pass through the illuminated portion of the flow, (iv) enhancing the image, and (v) processing the image to generate data relating to the particles captured therein.

This invention is concerned in general with multi-phase flows nowhere the primary phase is a fluid medium and the second phase is solid particulate matter, droplets of liquid or gas bubbles. The invention relates in particular, but not exclusively, to a device and a method for generating data relating to particles in a particulate material suspended in a fluid medium flowing within a pipe in a given flow direction.

The transportation of particulate materials by a carrier fluid is becoming more widespread. One type of fluid medium in which the particulate material may be suspended is air. Other types of fluid medium are also possible.

Accordingly the acquisition of data relating to the velocity and size of the particles within the fluid medium is becoming increasingly important. Such data includes, but is not limited to, the size of the particles and the mass flow rate of the particulate material. This information helps to increase productivity, improve product quality and raise process efficiency in many industries.

One example where pneumatic transportation of particulate material is employed is in coal-powered power stations. In such power stations real-time monitoring of pulverised fuel (PF) velocity, size distribution and mass flow rate permits the continuous adjustment of these parameters. This leads to improved combustion of the pulverised fuel by way of lower particle emissions, improved heat rate, and reduced residual carbon-in-ash.

A known way of measuring particle size in a fluid flow employs the principle of light scattering.

Such a principle involves a consideration of the fluctuation in intensity of light scattered by a body, i.e. particle, traversing two crossed laser beams. It is possible to generate a phase difference between the two scattered laser beams that is proportional to the size of the particle.

One such method that employs the foregoing principle is Phase Doppler Anemometry. In Phase Doppler Alnemometry the phase slift is calculated from the difference in path length of each incident laser beam as it is reflected or refracted by the particle. In practice the phase shift is calculated from the difference in path length of each incident laser beam with respect to a hypothetical central reference beam.

In general the larger a particle, the more light it scatters.

However, Phase Doppler Aliemometry (PDA) provides only a point measurement in space. The inability to sample over and area limits the ability of PDA in characterising multiphase flows.

In addition, PDA works best with spherical particles; is difficult to implement in industrial applications; and is unable to provide data relating to mass flow rates.

Further ways of determining particle size in a fluid flow are so-called Direct Imaging techniques. These techniques can be used for particles ranging in size from fractions of a micron to several millimetres and are valuable for their ability to provide data relating to particle size distribution and average particle size.

Conventional direct imaging techniques use movement of a particle during image capture to calculate data about the particle. However, the accuracy of the data obtained about the particles is poor.

Therefore, it is a general aim of the invention to provide a device and a method, for generating data relating to particles in a particulate material, which provides more accurate data regarding the particles than conventional techniques allow.

According to a first aspect of the invention there is provided a device, for generating data relating to particles in a particulate material suspended in a fluid medium flowing within a pipe in a given flow direction, comprising:
a light source arranged to illuminate a portion of the flow;
an image acquisition unit, for capturing an image of the particles as they pass through the illuminated portion of the flow, having a predetermined focal plane, and being arranged so that the focal plane is inclined relative to the flow direction of the particles; and
a processing unit, in communication with the image acquisition Unit, for enhancing the image and processing the enhanced image to generate data relating to the particles captured therein.

Inclining the focal plane of the image acquisition unit relative to the flow direction of the particles reduces the time that each particle is resident within the focal plane of the image acquisition unit during image capture. This reduces the degree of movement of the particles during image capture, thereby resulting in the acquisition of an accurate image of each particle. This and subsequent enhancement allows for the generation of more accurate data relating to the particles.

Preferably the device of the invention further includes a hollow test chamber arranged in fluid communication with the pipe, whereby a fraction of the flow is divertable into the test chamber, the light source being arranged to illuminate a portion of the flow within the test chamber, and the image acquisition unit being arranged so that the focal plane thereof is inclined relative to the flow direction of the particles in the test chamber.

This arrangement provides a convenient and practical way of locating the light source and the image acquisition unit relative to the fluid flow.

In a preferred embodiment of the invention the test chamber is located adjacent to a homogenising portion of the pipe having little or no pressure drop thereacross. This arrangement has the benefit of homogeneously mixing the particulate matter and ensuring that the flow extracted through the test chamber contains a representative sample of the particulates flowing through the main pipe.

Conveniently the test chamber includes inlet and outlet valves for controlling the flow within the test chamber. This allows the flow to be controlled simply and effectively.

In a further preferred embodiment of the invention the test chamber includes at least one window for providing optical access to the interior of the chamber. This arrangement allows the location of the image acquisition unit outside the test chamber. As a result the image acquisition unit is isolated from the fluid flow which may otherwise damage it.

Optionally the image acquisition unit is arranged so that the focal plane thereof is inclined at an angle of between 45° and 135° relative to the flow direction of the particles. Arranging the image acquisition unit in this way allows for convenient positioning of the image acquisition unit relative to the pipe while permitting the acquisition of an accurate image of the particles.

In another preferred embodiment of the invention the image acquisition unit is arranged so that the focal plane thereof is inclined at an angle of 90° relative to the flow direction of the particles. Such an arrangement minimises the period of time that each particle is resident within the focal plane of the image acquisition unit during image capture, thereby helping to eliminate movement of the particles during image capture and so allowing the capture of an accurate image of each particle.

Conveniently the light source is arranged to illuminate a plane within the flow with a sheet of light. The light source may be further arranged such that the sheet of light is coincident with the focal plane of the image acquisition unit.

Alternatively, the light source may be arranged to illuminate a three-dimensional volume within the flow.

Such arrangements are a convenient way of illuminating a portion of the flow.

In another preferred embodiment of the invention the image acquisition unit is or includes a digital camera having a charge coupled device for transforming an optical image into a digital image. A digital camera facilitates the real-time monitoring of the fluid flow. In addition, the conversion of an optical image into a digital image enables the images to be processed electronically.

Optionally the device further includes a telephoto lens and at least one spacer having a predetermined magnification. This arrangement allows the device to be used acquire images of particles flowing within a large stack of e.g. a power station.

Preferably the device also includes a control unit for coordinating the operation of the device, including one or more of the following:
(a) capturing images;
(b) processing to establish the size of respective particles;
(c) opening and closing of inlet and outlet valves;
(d) cleaning and purging of the or each window;
(e) determining the mass flow rate of the particulate material;
(f) determining the mass of particulates per unit volume; and
(g) interacting with external devices.

This arrangement removes the burden of controlling and coordinating the foregoing operations from a human operator, thereby allowing the device to function automatically, if desired.

According to a second aspect of the invention there is provided a method, for generating data relating to particles in a particulate material suspended in a fluid medium flowing within a pipe in a given flow direction, comprising the steps of:
(i) illuminating a portion of the flow;
(ii) arranging an image acquisition unit having a predetermined focal plane so that the focal plane is inclined relative to the flow direction of the particles;
(iii) capturing an image of the particles as they pass through the illuminated portion of the flow;
(iv) enhancing the image; and
(v) processing the image to generate data relating to the particles captured therein.

The method of the invention shares the advantages of the device of the invention.

Preferably the method includes the additional step before step (i) of diverting a fraction of the flow to be illuminated into a hollow test chamber.

The use of a test chamber provides a convenient way of arranging the necessary illuminating and image capturing equipment relative to the fluid flow.

In a preferred embodiment of the invention the step of enhancing the image includes using thresholding. This provides an improvement in contrast of the captured image which facilitates the generation of more accurate data relating to the particles.

Optionally processing the image includes using edge detection. The use of edge detection permits the automatic detection and analysis of the particles.

Preferably the data relating to the particles generated by processing the image includes at least one of:
(a) the size of respective particles captured in the image;
(b) the mass flow rate of the particulate material; and
(c) the mass of particulates per unit volume.

These are key parameters in many industrial processes. The ability to monitor and thereby control these parameters helps to improve productivity and process efficiency.

Conveniently the data generated further includes one or more of:
(d) real-time images of the flow;
(e) particulate distribution graphs; and
(f) a database of captured images for providing a record of the flow over time.

These data provide additional useful information to the operators of e.g. industrial processes, thereby facilitating the continuous improvement of such processes.

There now follows a brief description of preferred embodiments of the invention, by way of non-limiting examples, with reference being made to the accompanying drawings in which:

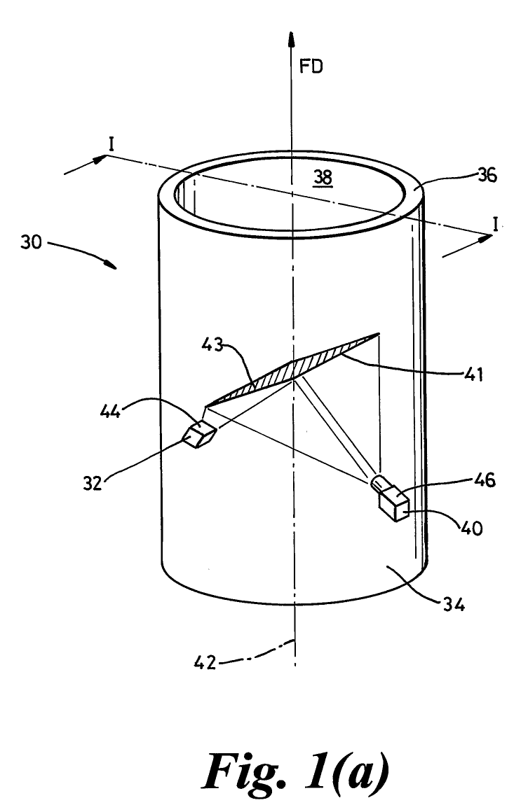

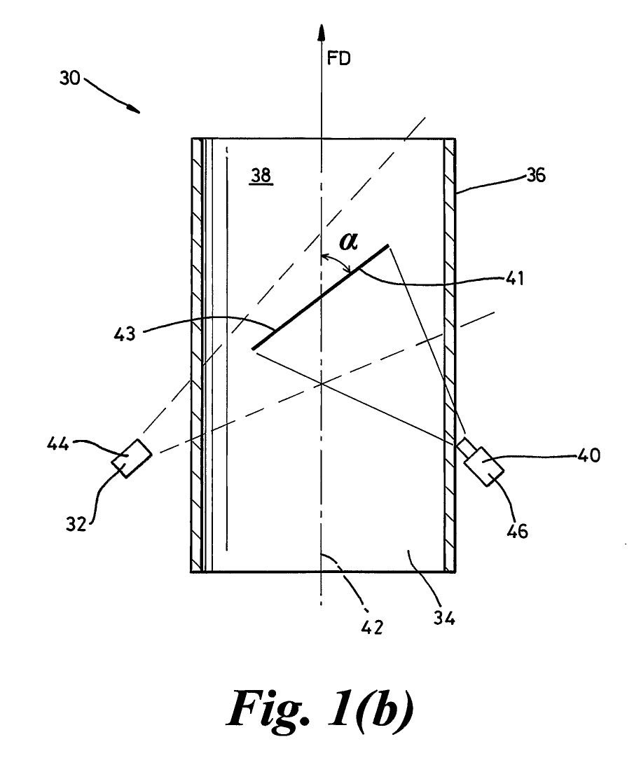

FIG. 1(a) shows a perspective view of a device according to a first embodiment of the invention;

FIG. 1(b) is a sectional view along line I-I of FIG. 1(a);

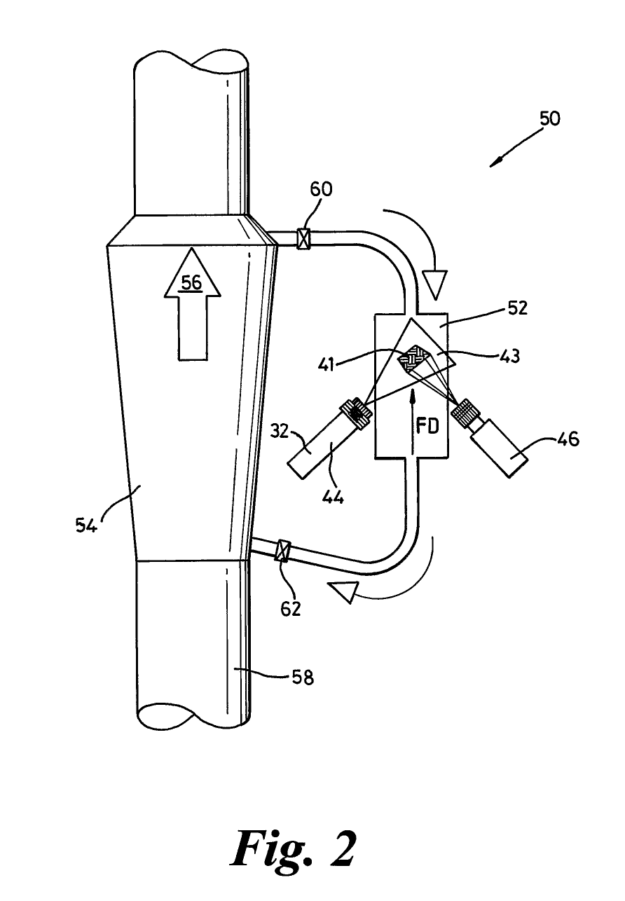

FIG. 2 is a schematic, plan view of a device according to a second embodiment of the invention;

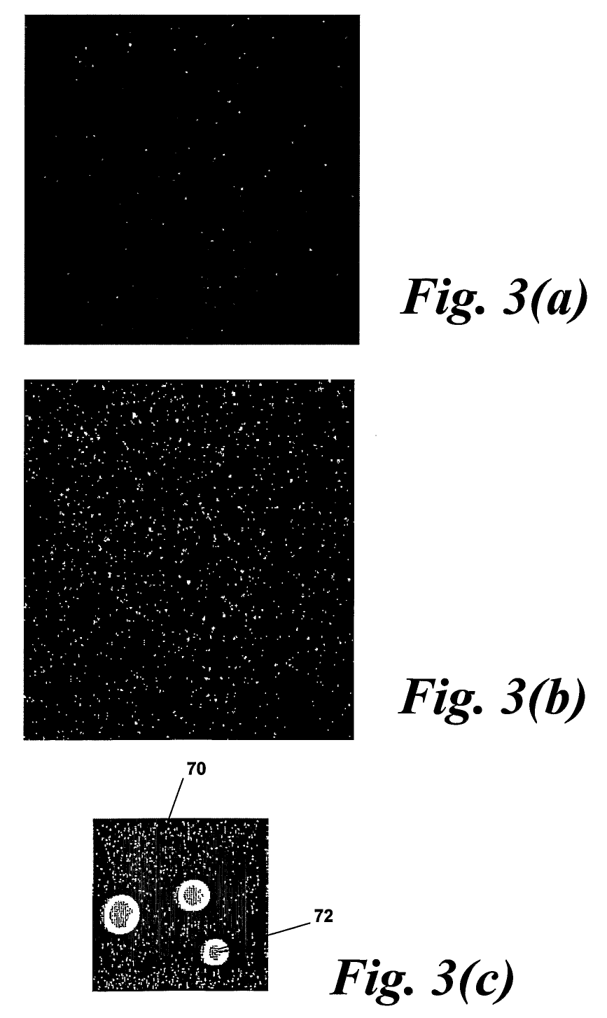

FIG. 3(a) is an image captured according to a method of the invention, prior to enhancement;

FIG. 3(b) is the image of FIG. 3(a) following enhancement thereof;

FIG. 3(c) is an enlarged portion of the image of FIG. 3(b);

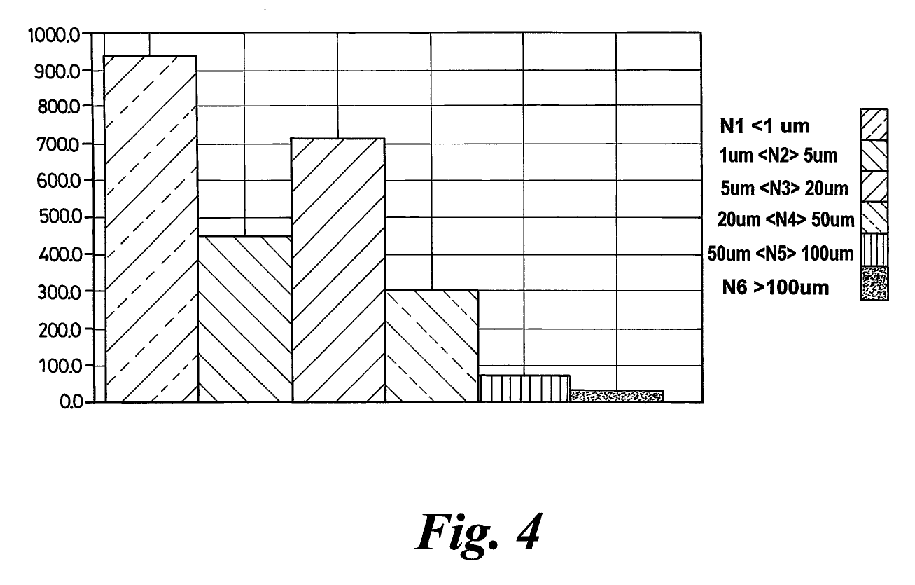

FIG. 4 is a first example of a particulate distribution graph;

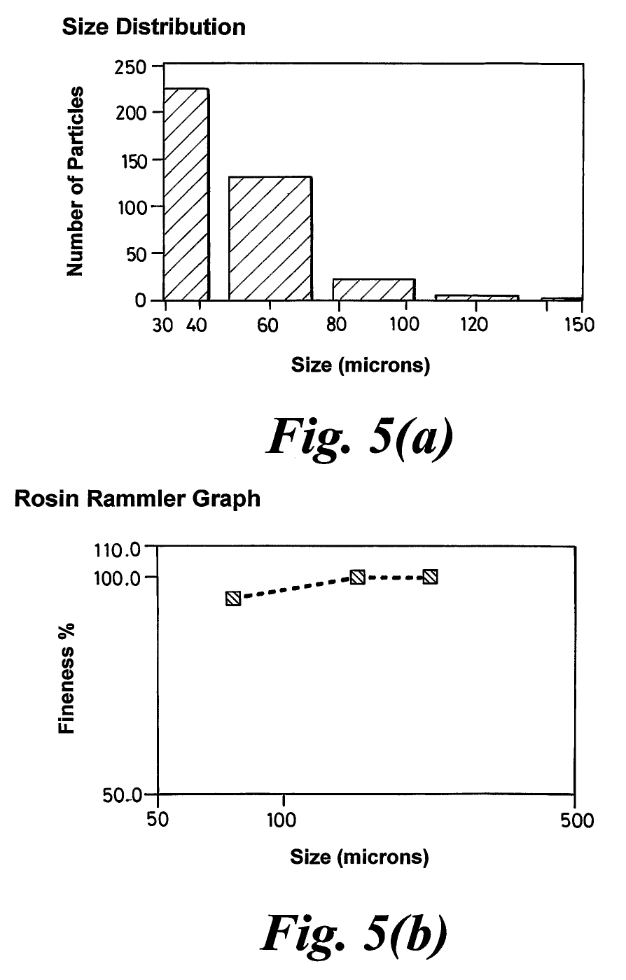

FIG. 5(a) and 5(b) are second and third examples of particulate distribution graphs;

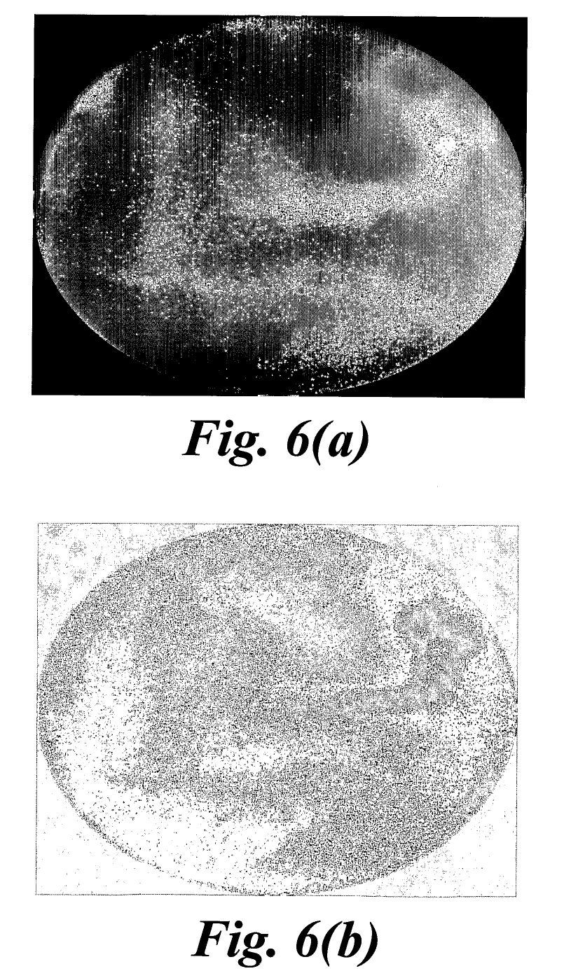

FIG. 6(a) is an image of particulate flow captured directly from within a pipe, prior to enhancement; and

FIG. 6(b) is the image of FIG. 6(a) following enhancement thereof.

A device, for generating data relating to particles, according to a first embodiment of the invention is designated generally by the reference numeral 30 (FIGS. 1(a) and 1(b)).

The device 30 comprises a light source 32 arranged to illuminate a portion of the flow within a stack 34 of a power station. In other embodiments of the invention the device 30 may be located in another type of pipe or a duct having any cross-sectional shape. The particles are flowing within the stack 34 in a given flow direction FD.

The light source 32 is located in a curved outer wall 36 of the stack 34. The light source 32 is arranged perpendicular to a tangent struck from the outer wall 36, thereby pointing towards the interior 38 of the stack.

The device 30 also includes an image acquisition unit 40 located within the outer wall 36 of the stack 34. The image acquisition unit 40 has a predetermined focal plane 41.

The image acquisition unit 40 is arranged so that its focal plane 41 is inclined at an angle a to the flow direction FD of the particles. In the embodiment shown a is 45°. Other values of a are also possible.

The light source 32 projects a sheet of light 43 into the interior 38 of the stack 34. The plane of the sheet of light 43 is arranged so as to be coincident with the focal plane 41 of the image acquisition unit 40. In other embodiments of the invention, the light source 32 may illuminate a three-dimensional volume having e.g. a frusto-conical shape or a cuboidal shape. Illuminating such a volume within the flow means that it is relatively easy to arrange for the focal plane 41 of the image acquisition unit 40 to lie within the illuminated volume.

In the arrangement shown, the image acquisition unit 40 is spaced from the light source 32 about an axis 42 passing through the centre of the stack 34 by an angle of 90°. The image acquisition unit 40 is also displaced along the length of the stack 34 relative to the light source 32.

In general the relative position and orientation of the light source 32, the image acquisition unit 40 and the illuminated portion of the flow depends on the extent of optical access to the stack 34 or other pipe. In addition, the hostility of the environment around the stack 34 or pipe is a factor in the aforemielntioned relative positioning and orientation.

Preferably the light source 32 is laser 44. A laser is able to illuminate a portion of the flow having the desired shape and/or volume. In addition, lasers are readily available and reliable in operation.

The image acquisition unit 40 is preferably a digital camera 46 having a charge coupled device (CCD). The CCD transforms an optical image into a digital image thereby allowing electronic processing of the image.

The digital camera 46 may include a telephoto lens 48 and a spacer (not shown in the drawings) having a predetermined magnification.

In addition, the digital camera 46 may include a lens (not shown) which is moveable relative thereto. Such an arrangement allows the lens to be positioned as desired so as to permit image acquisition while the camera is remote therefrom.

A device 50 according to a second embodiment of the invention further includes a hollow test chamber 52, as shown in FIG. 2. This embodiment shares the features of a light source and an image acquisition unit with the first embodiment. As a result corresponding reference numerals are used when describing these features in the second embodiment.

The test chamber 52 is arranged in fluid communication with a pipe 54. Consequently a fraction of a fluid flow 56 within the pipe 54 is divertable into the test chamber 52. The diverted fraction flows in a given flow direction FD.

Typically the fluid flow 56 is diverted into a test chamber 52 when the environment surrounding the pipe 54 is hostile. In this way the test chamber 52 provides a convenient arrangement for analysing the fluid flow 56 without interfering with the flow properties.

In a preferred embodiment of the invention the test chamber 52 is located adjacent to a homogenising portion 58 of the pipe 54. The homogenising portion 58 has little or no pressure drop across it and so the fluid flow 56 passing therethrough is smooth and so the particulate laden fluid flow 56 is homogeneously mixed.

The test chamber 52 shown in FIG. 2 includes an inlet valve 60 and an outlet valve 62.

Preferably the test chamber 52 also includes a window (not shown in FIG. 2) which allows the digital camera 46 to be located outside the chamber 52, thereby protecting it from the particulate material flowing therein.

In a similar arrangement to the first embodiment of the invention, the digital camera 46 is located so that its focal plane 41 is inclined relative to the flow direction FD of the particles in the test chamber 52. The light source 32 is arranged to project a sheet of light 43 into the hollow interior of the test chamber 52 in order to illuminate a plane within the flow. In other embodiments of the invention, the light source 32 may illuminate a three-dimensional volume within the flow.

Each of the first and second embodiments 30, 50 of the invention include a processing unit (not shown) which is in electronic communication with the digital camera 46.

The processing unit is for enhancing and processing the enhanced image to generate data relating to the particles captured in the image.

Furthermore, each of the first and second embodiments 30, 50 preferably include a control unit for coordinating the operation of the device 30, 50. Such operations may include capturing images; processing images to establish the size of respective particles; opening and closing of inlet and outlet valves 60, 62; cleaning and purging of the window in the test chamber 52; determining the mass flow rate of the particulate material; determining the mass of particles per unit volume, i.e. the “particulate loading”; and interacting with external devices.

The control unit can be either a computer running a Microsoft (RTM) Windows (RTM) operating system, or a National Instrument (RTM) compact vision system running Labview (RTM).

External devices may include monitors and displays, printers, fans and other accessories. The control unit may also transmit data to a remote location such as a plant control room.

A first embodiment of a method of the invention comprises the step of illuminating a portion of the flow. This permits the capture of an image of the particles. Preferably a laser is used to illuminate the flow.

The method also includes the step of arranging an image acquisition unit 40 having predetermined focal plane 41 so that the focal plane 41 is inclined relative to the flow direction FD of the particles. Inclining the focal plane 41 in this way reduces the time that each particle is resident within the focal plane 41 of the image acquisition unit 40 during image capture. This reduces the degree of movement of the particles during image capture, thereby resulting in the acquisition of an accurate image of each particle.

The method further includes capturing an image of the particles as they pass through illuminated portion of the flow. As discussed above, a digital camera 46 having a CCD may be used to capture the image. In such an arrangement the digital camera 46 captures an image having a predetermined resolution. The resolution of the camera 46 determines the number of pixels in each image.

Typically each pixel within the image is assigned one of 256 levels of grey, although in other embodiments of the invention different bit depths are possible.

The first embodiment method further includes the step of enhancing the image. Enhancing the image includes adaptive thresholding.

Adaptive thresholding consists of a series of iterative steps in which a processing unit determines what is a particle and what is not. Thresholding involves the processing unit specifying the range of grey levels which are used to display the image, according to the particle of interest. The processing unit takes into account the quality of the raw, original image, as well as the particulate density, when determining the range of grey levels. The processing unit selects the range of grey levels so as to best isolate one or more particles from the background.

FIG. 3(a) shows an image before enhancement. FIG. 3(b) shows the FIG. 3(a) image following enhancement using thresholding. FIG. 3(c) shows an enlarged portion of the FIG. 3(b) image. All pixels in the image that are darker than a given level of grey are displayed as black 70. The processing unit adjusts the level of grey, i.e. the threshold, at which this transition occurs in order to separate out the particles of interest 72. Each particle of interest 72 appears as lighter, grey tones. In this way an accurate, high contrast image of the particles is obtained.

Following the step of enhancing the image it is possible to process the image to generate data relating to the particles captured therein. For example, the processing unit generates data relating to the separate areas corresponding to the particles of interest identified by thresholding.

The use of an accurate, high contrast image allows for the calculation of more accurate data regarding the particles. For example, an accurate image of the particles allows the centroid of each particle to be determined accurately, thereby resulting in an accurate calculation of the velocity of each particle which, in turn, allows for an accurate determination of the mass flow rate of the particles.

An automatic way of detecting the separate areas corresponding to the particles is to use edge detection. Edge detection measures the intensity change between adjacent pixels in an image. A respective pixel is set to a, so-called, “edge point” if the intensity difference exceeds a predetermined value.

Preferably the generated data relating to the particles includes the size of respective particles, the particulate loading, or the mass flow rate of the particulate material, The size of respective particles may include the diameter of spherical particles, the characteristic dimensions of non-spherical particles, or other shape factors.

In addition, the generated data may also include real-time images of the flow. Particulate distribution graphs may also be produced. FIGS. 4, 5(a) and 5(b) show examples of particulate distribution graphs.

FIG. 4 shows a 5-bar histogram indicating the particle count within predetermined size ranges.

FIG. 5(a) shows another 5-bar histogram which indicates the distribution of particle size within the particulate matter. FIG. 5(b) shows the corresponding Rosin Ranuler graph depicting the degree of fineness of the particulate matter.

Particularly useful data includes a database of captured images of the flow. This provides a record of changes in the flow with respect to time, thereby allowing analysis of the flow.

FIG. 6(a) shows a raw image of particulate flow captured directly from within a pipe, prior to enhancement. FIG. 6(b) shows the FIG. 6(a) image following enhancement.

1-19. (canceled)

20. A device, for generating data relating to particles in a particulate material suspended in a fluid medium flowing within a pipe in a given flow direction, comprising:
a hollow test chamber fluidly connected to the pipe by a fluid conduit, a fraction of the flow within the pipe being divertable into the fluid conduit for transfer to the test chamber;
a light source arranged to illuminate a portion of the flow fraction within the test chamber;
an image acquisition unit, for capturing an image of the particles as they pass through the illuminated portion of the flow fraction, having a predetermined focal plane, and being arranged so that the focal plane is inclined relative to the flow direction of the particles; and
a processing unit, in communication with the image acquisition unit, for enhancing the image and processing the enhanced image to generate data relating to the particles captured therein

21. A device according to claim 20 wherein the test chamber is located adjacent to a homogenising portion of the pipe having little or no pressure drop thereacross.

22. A device according to claim 20 or claim 21 wherein the test chamber includes inlet and outlet valves for controlling the flow within the test chamber.

23. A device according to any preceding claim wherein the test chamber includes at least one window for providing optical access to the interior of the chamber.

24. A device according to any preceding claim wherein the image acquisition unit is arranged so that the focal plane thereof is inclined at an angle of between 45° and 135° relative to the flow direction of the particles.

25. A device according to any preceding claim wherein the image acquisition unit is arranged so that the focal plane thereof is inclined at an angle of 90° relative to the flow direction of the particles.

26. A device according to any preceding claim wherein the light source is arranged to illuminate a plane within the flow fraction with a sheet of light.

27. A device according to claim 26 wherein the light source is arranged such that the sheet of light is coincident with the focal plane of the image acquisition unit.

28. A device according to any of claims 20 to 25 wherein the light source is arranged to illuminate a three-dimensional volume within the flow fraction.

29. A device according to any preceding claim wherein the image acquisition unit is or includes a digital camera having a charge coupled device for transforming an optical image into a digital image.

30. A device according to claim 29 further including a telephoto lens and at least one spacer having a predetermined magnification.

31. A device according to any preceding claim including a control unit for coordinating the operation of the device, including one or more of the following:
(a) capturing images;
(b) processing to establish the size of respective particles;
(c) opening and closing of inlet and outlet valves;
(d) cleaning and purging of the or each window;
(e) determining the mass flow rate of the particulate material;
(f) determining the mass of particulates per unit volume; and
(g) interacting with external devices.

32. A method, for generating data relating to particles in a particulate material suspended in a fluid medium flowing within a pipe in a given flow direction, comprising the steps of:
(i) diverting a fraction of the flow into a hollow test chamber fluidly connected to the pipe by a fluid conduit;
(ii) illuminating a portion of the flow fraction within the test chamber;
(iii) arranging an image acquisition unit having a predetermined focal plane so that the focal plane is inclined relative to the flow direction of the particles in the test chamber;
(iv) capturing an image of the particles as they pass through the illuminated portion of the flow fraction;
(v) enhancing the image; and
(vi) processing the image to generate data relating to the particles captured therein.

33. A method according to claim 32 wherein the step of enhancing the image includes using thresholding.

34. A method according to claim 32 or claim 33 wherein processing the image includes using edge detection.

35. A method according to any of claims 32 to 34 wherein the data relating to the particles generated by processing the image includes at least one of
(a) the size of respective particles captured in the image;
(b) the mass flow rate of the particulate material; and
(c) the mass of particulates per unit volume.

36. A method according to claim 35 wherein the data generated further includes one or more of:
(c) real-time images of the flow;
(d) particulate distribution graphs; and
(e) a database of captured images for providing a record of the flow over time.
